(19) United States
(12) Patent Application Publication
(10) Pub. No.: US 2019/0099750 A1
(43) Pub. Date: Apr. 4, 2019

(54) ION EXCHANGE DEVICE AND METHOD OF USING SAME

(71) Applicant: KURITA WATER INDUSTRIES LTD., Tokyo (JP)

(72) Inventors: Yoichi MIYAZAKI, Tokyo (JP); Hideaki IINO, Tokyo (JP); Naoki FUKASAWA, Tokyo (JP)

(21) Appl. No.: 16/085,998

(22) PCT Filed: Mar. 16, 2017
(86) PCT No.: PCT/JP2017/010750

§ 371 Date: Sep. 17, 2018

(30) Foreign Application Priority Data
Mar. 18, 2016 (JP) 2016-055690

(51) Int. Cl. B01J 47/022; B01J 47/028; B01J 49/08; C02F 1/42

(52) U.S. Cl. CPC B01J 47/022; C02F 1/42; B01J 49/08; B01J 47/028

(57) ABSTRACT

An ion exchange device is used that includes an anion exchange tank, a cation exchange tank and a tower body side portion, in which the anion exchange tank and the cation exchange tank are allowed to communicate by communication means that is arranged around the outside of the anion exchange tank and the cation exchange tank. The ion exchange device also includes supply/discharge pipes for supplying or discharging a liquid to or from an upper portion and a lower portion of the anion exchange tank, and supply/discharge pipes for supplying or discharging a liquid to or from an upper portion and a lower portion of the cation exchange tank. A water collection/distribution member that allows water to pass but prevents passage of an ion-exchange resin is provided in a flat plate.

### TECHNICAL FIELD

The present invention relates to a double-bed, single-tower regenerative pure water production device that includes an anion-exchange resin and a cation-exchange resin and which is used in a technical field in which raw water such as industrial water is passed through a packed bed of ion-exchange resin to produce pure water.

### BACKGROUND ART

To produce pure water from raw water such as industrial water, for example, an operation is performed in which the raw water is passed through a device equipped with a tower in which an ion-exchange resin is packed to thereby remove various components included in the raw water. Examples of devices that are equipped with a tower in which an ion-exchange resin is packed that are used for such pure water production include a mixed bed tower in which a cation-exchange resin and an anion-exchange resin are mixed and packed in a single tower, and a multi-bed towers in which a cation-exchange resin and an anion-exchange resin are packed in respectively separate towers.

For example, a single-tower method (see FIG. 1) is available in which a cation-exchange resin and an anion-exchange resin are stacked in a state in which a partition plate is interposed therebetween in the same single tower. Because the structure of a device adopting the single-tower method is simple, devices manufactured according to the single-tower method as shown in FIG. 1 have conventionally been adopted (for example, see Patent Document 1).

When raw water is passed through a pure water production device that includes a cation-exchange resin and an anion-exchange resin in this manner, ions contained in the raw water are removed by the action of the cation-exchange resin and the anion-exchange resin, and pure water is obtained.

In this connection, for example, in a plant that manufactures electronic materials such as semiconductor material, a large amount of pure water of high purity is required, and furthermore, depending on the geographical conditions of the manufacturing plant, a compact pure water production device is required.

In addition, for maintenance of the pure water production device, there has been a desire for the device to have a structure that allows maintenance personnel or the like to enter into the device and that also allows personnel to check the state of the resin that is packed in the device from outside.

In the ion exchange device described in Patent Document 1, a tower body for an ion exchange device in which ion-exchange resin is packed is partitioned to form an upper chamber and a lower chamber by providing a water-impermeable partition plate that is curved in a convex shape inside the tower body, and the ion exchange device includes a supply/discharge pipe for supplying and discharging a liquid to and from the upper chamber and lower chamber, communication means for supplying/discharging a liquid, and opening/closing means for opening/closing a communication pipe. In addition, a water collection/distribution member (water collection/distribution pipe) that allows water to pass therethrough but prevents the passage of ion-exchange resin is arranged in each of an upper portion of the upper chamber, a lower portion of the upper chamber, an upper portion of the lower chamber and a lower portion of the lower chamber. The water collection/distribution member in the lower portion of the upper chamber and the water collection/distribution member in the upper portion of the lower chamber have a shape that follows the shape of the partition plate, and the ion exchange device has a structure in which granular inert resin is packed in the upper portion of the upper chamber and the upper portion of the lower chamber.

However, the aforementioned device has the following problems.

1) The water collection/distribution members include members having a form like the ribs of an umbrella that spread radially from the center to a peripheral portion along the partition plate. In such case, an interval between the water collection/distribution pipes widens at the peripheral portion compared to the center portion, and stagnant portions are liable to arise. This tendency becomes more noticeable as the device size increases, and hence there is a limit to the treatment capacity.
2) Although the inert resin packed in the upper portion of the upper chamber and the upper portion of the lower chamber is provided for purposes such as improving the efficiency of regeneration of the ion-exchange resin, it is necessary to increase the height of the ion exchange device in accordance with the volume that corresponds to the amount of inert resin to be packed.

Further, in the case of a double bed-type device in which an anion-exchange resin and a cation-exchange resin are packed in respectively different towers, there are the following problems.

1) It is necessary to separately install a tower in which an anion-exchange resin is packed and a tower in which a cation-exchange resin is packed, and typically these towers are installed side by side. Consequently, it is necessary to secure the space that is required for installation of these towers, and it has been difficult to secure sufficiently wide space for installing such devices within treatment plants that have limited space.
2) In the case of causing the towers to communicate by means of pipes, in a configuration in which the towers are arranged side by side, the length of the pipes is long, and furthermore in some cases the structure can become complex and management of the plant can become difficult.

### PRIOR ART DOCUMENT

### Patent Document

Patent Document 1: Japanese Patent No. 5672687 (Claims, FIG. 1)

### SUMMARY OF THE INVENTION

### Problems to be Solved by the Invention

The present invention has been made in view of the circumstances described above, and an object of the present invention is to provide a device for which maintenance is easy even though the device is a compact size that requires only a small installation area. Another object is to provide a device that has a large raw water treatment capacity. Yet another object is to provide a device that can efficiently perform regeneration of an ion-exchange resin.

### Means for Solving the Problems

The present inventors conducted intensive studies with respect to solving the conventional problems, and as a result discovered that by providing a double-bed, single-tower-type device having a tank in which an anion-exchange resin is packed (hereunder, referred to as “anion exchange tank”) and a tank in which a cation-exchange resin is packed (hereunder, referred to as “cation exchange tank”) and in which either one of the cation exchange tank and the anion exchange tank is installed at an upper part and the other of the cation exchange tank and the anion exchange tank is installed at a lower part and which also includes a holding member that vertically holds the anion exchange tank and the cation exchange tank in a state in which there is a space therebetween, an ion exchange device can be provided with respect to which the area occupied by the device can be reduced, and which can be efficiently operated in a plant as a single tower in which an anion exchange tank and a cation exchange tank are integrated and for which maintenance is also easy.

In addition, the present inventors discovered that by installing a flat plate in an upper portion and a lower portion of each of the anion exchange tank and the cation exchange tank to partition an upper chamber, a resin-packed chamber and a lower chamber of the respective exchange tanks from each other, and also installing a water collection/distribution member (water collection/distribution pipe) that allows water to pass therethrough but prevents the passage of an ion-exchange resin at a predetermined position in the flat plate, bulk treatment of raw water can be realized and, furthermore, the time taken from resin regeneration until resumption of operations can be shortened, and thereby completed the present invention.

The present invention is described in detail hereunder.

An ion exchange device according to one aspect of the present invention includes, at an upper part, an anion exchange tank in which an anion-exchange resin is packed, and at a lower part, a cation exchange tank in which a cation-exchange resin is packed, wherein:

the anion exchange tank and the cation exchange tank each independently have an outer shell that is constituted by end plates having an outwardly convex shape that are provided at an upper portion and a lower portion and also by a support body of an ion exchange tank side portion, and include an upper chamber, a resin-packed chamber and a lower chamber which are partitioned from each other by two upper and lower flat plates; and

the anion exchange tank and the cation exchange tank are allowed to communicate by communication means provided outside of the anion exchange tank and the cation exchange tank;

the ion exchange device further including a supply/discharge pipe for supplying or discharging a liquid to or from the upper portion of the anion exchange tank, and a supply/discharge pipe for supplying or discharging a liquid to or from the lower portion of the cation exchange tank;

the communication means including:

a first communication pipe for supplying/discharging a liquid to/from the lower portion of the anion exchange tank,

a second communication pipe for supplying/discharging a liquid to/from the upper portion of the cation exchange tank,

a third communication pipe that allows the first communication pipe and the second communication pipe to communicate,

opening/closing means for opening/closing the third communication pipe, and

supply/discharge means for supplying/discharging a regenerant solution, that is provided in each of the first communication pipe and the second communication pipe;

wherein:

a water collection/distribution member that allows water to pass therethrough and prevents passage of an ion-exchange resin is disposed in the flat plate, and

the supply/discharge pipe at the upper portion of the anion exchange tank, the first communication pipe, the second communication pipe and the supply/discharge pipe at the lower portion of the cation exchange tank, that is, respective ends of the pipes, communicate with end plates provided at the upper portion and the lower portion of the anion exchange tank and the cation exchange tank, respectively.

An ion exchange device according to another aspect of the present invention includes, at an upper part, a cation exchange tank in which a cation-exchange resin is packed, and at a lower part, an anion exchange tank in which an anion-exchange resin is packed, wherein:

the cation exchange tank and the anion exchange tank each independently have an outer shell that is constituted by end plates having an outwardly convex shape that are provided at an upper portion and a lower portion and also by a support body of an ion exchange tank side portion, and include an upper chamber, a resin-packed chamber and a lower chamber which are partitioned from each other by two upper and lower flat plates; and

the cation exchange tank and the anion exchange tank are allowed to communicate by communication means provided outside of the cation exchange tank and the anion exchange tank;

the ion exchange device further including a supply/discharge pipe for supplying or discharging a liquid to or from the upper portion of the cation exchange tank, and a supply/discharge pipe for supplying or discharging a liquid to or from the lower portion of the anion exchange tank;

the communication means including:

a first communication pipe for supplying/discharging a liquid to/from the lower portion of the cation exchange tank,

a second communication pipe for supplying/discharging a liquid to/from the upper portion of the anion exchange tank,

a third communication pipe that allows the first communication pipe and the second communication pipe to communicate,

opening/closing means for opening/closing the third communication pipe, and

supply/discharge means for supplying/discharging a regenerant solution, that is provided in each of the first communication pipe and the second communication pipe;

wherein:

a water collection/distribution member that allows water to pass therethrough and prevents passage of an ion-exchange resin is disposed in the flat plate, and

the supply/discharge pipe at the upper portion of the cation exchange tank, the first communication pipe, the second communication pipe and the supply/discharge pipe at the lower portion of the anion exchange tank, that is, respective ends of the pipes, communicate with end plates provided at the upper portion and the lower portion of the anion exchange tank and the cation exchange tank, respectively.

Further, in the device of the present invention, as installation variations with respect to the water collection/distribution member in the water-impermeable flat plates, the water collection/distribution member can be installed at fixed intervals on a plurality of concentric circles that are separated by a fixed interval from a center portion of the flat plate, or can be installed so as to be at fixed intervals lengthwise and crosswise on the flat plate. Further, when the water collection/distribution member has a conical shape, the water collection/distribution member can be installed so as to project in a conical shape toward a side of the ion-exchange resin bed of the flat plate, and when the water collection/distribution member has a cylindrical shape, the water collection/distribution member can be installed so as to project from both a front side and a rear side of the flat plate. In addition, when the water collection/distribution member has a cylindrical shape, between the flat plates and the ion-exchange resin beds the ion exchange device has beds in which granular inert resin is packed, and in which the water collection/distribution member of the upper portion of the anion exchange tank and the water collection/distribution member of the upper portion of the cation exchange tank are embedded in the inert resin, respectively.

In the device of the present invention, the cross-sectional shape of the anion exchange tank and the cross-sectional shape of the cation exchange tank are each a substantially circular shape, and preferably the cross-sectional diameter of the anion exchange tank and the cross-sectional diameter of the cation exchange tank are the same length, and the respective cross-sections have a predetermined diameter. Although the diameter of the cross-section is not particularly limited, the diameter is preferably 500 mm or more from the viewpoint of the relation between the treatment amount of the water to be treated and the linear velocity (LV), and preferably the diameter is not more than 3000 mm. Further, in the device of the present invention, it is favorable for the bed height of an anion-exchange resin bed and the bed height of a cation-exchange resin bed to be a predetermined height.

Further, in the device of the present invention, it is favorable for a distance between a lower end of the anion exchange tank and an upper end of the cation exchange tank, and for a distance between a lower end of the cation exchange tank and an upper end of the anion exchange tank to be a predetermined distance.

As a method of using the ion exchange device having an anion exchange tank and a cation exchange tank of the present invention, to feed raw water into the cation exchange tank and cause ion-exchange resin to float and perform treatment of the raw water, it is preferable to feed the raw water at a linear velocity (LV) of 50 m/hr or more.

### Advantageous Effects of the Invention

The ion exchange device according to the present invention provides the following advantageous effects:

1) Because the ion exchange device is a compact size that requires only a small installation area, most of the area inside a plant can be allocated to the production section, and effective utilization of the facilities can be achieved.
2) Because the ion exchange device has a large raw water treatment capacity, the ion exchange device is also adaptable to a case where a large amount of pure water of high purity is used, such as in a semiconductor material manufacturing plant.
3) Since regeneration of ion-exchange resin can be efficiently performed, the start-up of pure water production after a regeneration treatment is fast, and efficient operations can be performed.

### BRIEF DESCRIPTION OF THE DRAWINGS

FIG. 1 is a schematic cross-sectional view illustrating a single-tower type ion exchange device according to the prior art in which cation-exchange resin and anion-exchange resin are stacked in a single tower with a partition plate interposed therebetween.

FIG. 2 is a multi-view drawing that includes schematic cross-sectional views illustrating an ion exchange device including an anion exchange tank at an upper part of a tower and a cation exchange tank at a lower part of the tower according to the present invention, in which FIG. 2a illustrates an example in which water collection/distribution members (strainers) are a conical shape, and FIG. 2b illustrates an example in which water collection/distribution members (strainers) are a cylindrical shape.

FIG. 3 is a multi-view drawing that includes schematic cross-sectional views illustrating an ion exchange device including a cation exchange tank at an upper part of a tower and an anion exchange tank at a lower part of the tower according to the present invention, in which FIG. 3a illustrates an example in which water collection/distribution members (strainers) are a conical shape, and FIG. 3b illustrates an example in which water collection/distribution members (strainers) are a cylindrical shape.

FIG. 4 is a multi-view drawing that includes schematic cross-sectional views of the ion exchange device of the present invention when using the ion exchange device to subject raw water (water to be treated) to an ion-exchange treatment (FIG. 4a and FIG. 4c), and when performing regeneration of resin (FIG. 4b and FIG. 4d), in which FIG. 4a and FIG. 4b illustrate examples in which the water collection/distribution members (strainers) are a conical shape, and FIG. 4c and FIG. 4d illustrate examples in which the water collection/distribution members (strainers) are a cylindrical shape.

FIG. 5 a multi-view drawing that includes schematic cross-sectional views illustrating conical water collection/distribution members prior to assembly in a flat plate (FIGS. 5a, 5b, c-1, c-2) and after assembly (FIG. 5d), of which FIG. 5c-1 is a view in which a side view of a member 7a shown in FIG. 5a is seen from above, and FIG. 5c-2 is an enlarged view of the member 7a shown in FIG. 5a.

FIG. 6 a multi-view drawing that includes a cross-sectional enlarged view (FIG. 6a) illustrating a state in which cylindrical water collection/distribution members are installed in a flat plate, and a cross-sectional enlarged view (FIG. 6b) illustrating a state in which a portion at which the cylindrical water collection/distribution members protrude on a side enclosed by upper and lower flat plates is packed with an inert resin.

FIG. 7 a multi-view drawing that includes schematic diagrams illustrating states in which water collection/distribution members are installed in a flat plate, which are schematic diagrams that illustrate variations in the installation positions of the water collection/distribution members (FIG. 7a to d).

FIG. 8 is a view showing results of producing pure water by means of the ion exchange device of the present invention according to Example 1, in which a black diamond shape (♦) indicates a result for new resin, the abscissa axis (X-axis) represents the water feeding time period (minutes), and the axis of ordinates (Y-axis) represents the TOC concentration (unit is ppb as C).

FIG. 9 is a view illustrating results obtained by studying the influence of installation of the strainers that are incorporated into the ion exchange device of the present invention according to Example 1 which, as illustrated in the drawing, shows results for a case in which a conventional strainer and inert resin were combined (shown as “conventional strainer+inert resin”) and a case in which a new strainer was used, in which the abscissa axis (X-axis) represents the water feeding time period (hours), and the axis of ordinates (Y-axis) represents a specific resistance value (unit is MΩ-cm).

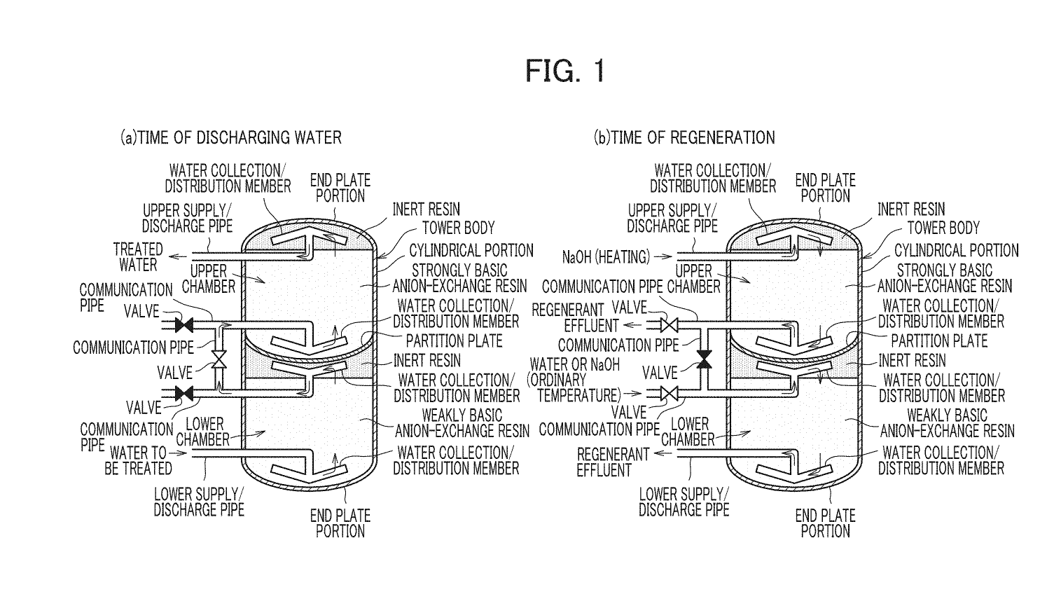

### MODE FOR CARRYING OUT THE INVENTION

Hereunder, an embodiment of the present invention is described with reference to the drawings.

### <Ion Exchange Device>

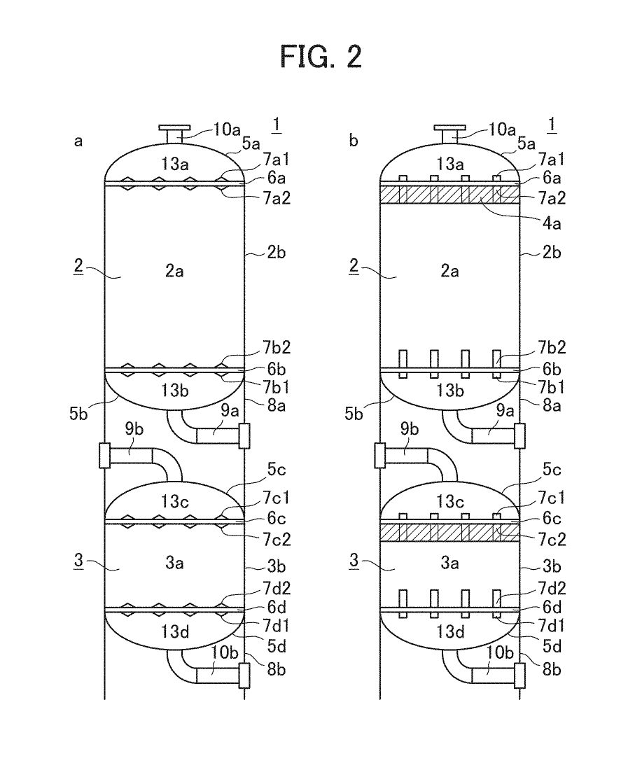

In FIG. 2, as an example of the device of the present invention, a schematic drawing of an ion exchange device (1) is shown that includes, at an upper part, an anion exchange tank (2) in which an anion-exchange resin is packed, and at a lower part, a cation exchange tank (3) in which a cation-exchange resin is packed.

The anion exchange tank (2) constituting one part of the ion exchange device (1) of the present invention has an outer shell that is constituted by a trunk (2b) that is a side portion of the anion exchange tank when taking the center direction of the cylindrical axis as the vertical direction, an end plate (5a) at a top part, and an end plate (5b) at a bottom part.

Further, the cation exchange tank (3) constituting one part of the ion exchange device (1) of the present invention has an outer shell that is constituted by a trunk (3b) that is a side portion of the cation exchange tank when taking the center direction of the cylindrical axis as the vertical direction, an end plate (5c) at a top part, and an end plate (5d) at a bottom part. The aforementioned end plate (5a) and end plate (5c) curve convexly upward, and the end plate (5b) and end plate (5d) curve convexly downward.

The anion exchange tank (2) is partitioned into three chambers, namely, an upper chamber (13a), an anion-exchange-resin packed chamber (2a), and a lower chamber (13b) by an upper flat plate (6a) and a lower flat plate (6b) that are impermeable to water. Further, the cation exchange tank (3) is partitioned into three chambers, namely, an upper chamber (13c), a cation-exchange-resin packed chamber (3a), and a lower chamber (13d) by an upper flat plate (6c) and a lower flat plate (6d) that are impermeable to water.

The flat plates 6 (6a to 6d) are made from metal or a synthetic resin which allows absolutely no water to pass therethrough, and the flat plates 6 (6a to 6d) have a planar structure.

First water collection/distribution members (7a) are disposed in the flat plate (6a) that partitions the upper chamber (13a) and the anion-exchange-resin packed chamber (2a) of the anion exchange tank (2) so as to penetrate the flat plate (6a) in a manner in which water collection/distribution members (7a1) are on the upper chamber (13a) side and water collection/distribution members (7a2) are on the anion-exchange-resin packed chamber (2a) side, and the water collection/distribution members (7a1) on the upper chamber (13a) side of the first water collection/distribution members (7a) communicate through the upper chamber (13a) with an upper supply/discharge pipe (10a) that has an end connected to the end plate (5a).

Second water collection/distribution members (7b) are disposed in the flat plate (6b) that partitions the lower chamber (13b) and the anion-exchange-resin packed chamber (2a) of the anion exchange tank (2) so as to penetrate the flat plate (6b) in a manner in which water collection/distribution members (7b1) are on the lower chamber (13b) side and water collection/distribution members (7b2) are on the anion-exchange-resin packed chamber (2a) side, and the water collection/distribution members (7b1) on the lower chamber (13b) side of the second water collection/distribution members (7b) communicate through the lower chamber (13b) with a first communication pipe (9a) that has an end connected to the end plate (5b).

The cation exchange tank (3) is similar to the anion exchange tank (2), and is described hereunder.

Third water collection/distribution members (7c) are disposed in the flat plate (6c) that partitions the upper chamber (13c) and the cation-exchange-resin packed chamber (3a) of the cation exchange tank (3) so as to penetrate the flat plate (6c) in a manner in which water collection/distribution members (7c1) are on the upper chamber (13c) side and water collection/distribution members (7c2) are on the anion-exchange-resin packed chamber (3a) side, and the water collection/distribution members (7c1) on the upper chamber (13c) side of the third water collection/distribution members (7c) communicate through the upper chamber (13c) with a second communication pipe (9b) that has an end connected to the end plate (5c).

Fourth water collection/distribution members (7d) are disposed in the flat plate (6d) that partitions the lower chamber (13d) and the cation-exchange-resin packed chamber (3a) of the cation exchange tank (3) so as to penetrate the flat plate (6d) in a manner in which water collection/distribution members (7d1) are on the lower chamber (13d) side and water collection/distribution members (7d2) on the anion-exchange-resin packed chamber (3a) side, and the water collection/distribution members (7d1) are on the lower chamber (13d) side of the fourth water collection/distribution members (7d) communicate through the lower chamber (13d) with a lower supply/discharge pipe (10b) that has an end connected to the end plate (5d).

In addition, in the ion exchange device (1) having an anion exchange tank at an upper part of a tower and a cation exchange tank at a lower part of the present invention, a tower body trunk (8a) taking the center direction of the cylindrical axis as the vertical direction is installed between the lower flat plate (6b) of the anion exchange tank (2) and the upper flat plate (6c) of the cation exchange tank (3) which constitute a part of the ion exchange device (1), and a tower body trunk (8b) taking the center direction of the cylindrical axis as the vertical direction is installed in the area downward from the lower flat plate (6d) of the cation exchange tank (3).

The tower body trunk (8a) and the tower body trunk (8b) can support the anion exchange tank (2) and the cation exchange tank (3) of the ion exchange device (1) of the present invention, and can also connect and support the pipes described above.

Specifically, the first communication pipe (9a) communicates through the lower chamber (13b) with the water collection/distribution members (7b1) on the lower chamber (13b) side of the second water collection/distribution members (7b), and the first communication pipe (9a) is supported at a predetermined position of the tower body trunk (8a) and is used to introduce raw water that passed through the cation exchange tank (3) and also to discharge a sodium hydroxide (NaOH) aqueous solution that is a regenerant solution for the anion-exchange resin.

Further, the second communication pipe (9b) communicates through the upper chamber (13c) with the water collection/distribution members (7c1) on the upper chamber (13c) side of the third water collection/distribution members (7c), and the second communication pipe (9b) is supported at a predetermined position of the tower body trunk (8a) and is used to discharge raw water that passed through the cation exchange tank (3) and also to introduce a hydrochloric acid (HCl) aqueous solution that is a regenerant solution for the cation-exchange resin.

In addition, the pipe (10b) communicates through the lower chamber (13d) with the water collection/distribution members (7d1) on the lower chamber (13d) side of the fourth water collection/distribution members (7d), and the pipe (10b) is supported at a predetermined position of the tower body trunk (8a), and is used to introduce raw water and also to discharge the hydrochloric acid (HCl) aqueous solution that is a regenerant solution for the cation-exchange resin.

### <Switching of Communication Pipes>

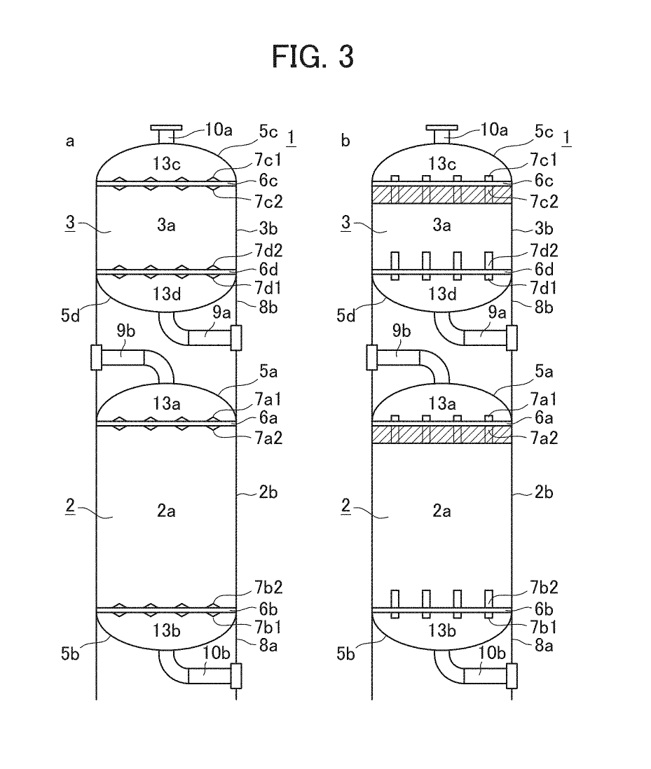

The second water collection/distribution members (7b) are installed in the lower flat plate (6b) of the anion exchange tank (2), and the water collection/distribution members (7b1) on the lower chamber (13b) side of the second water collection/distribution members (7b) are connected through the lower chamber (13b) to the first communication pipe (9a). Further, the third water collection/distribution members (7c) are installed in the upper flat plate (6c) of the cation exchange tank (3), and the water collection/distribution members (7c1) on the upper chamber (13c) side of the third water collection/distribution members (7c) are connected through the upper chamber (13c) to the second communication pipe (9b). In addition, the first communication pipe (9a) and the second communication pipe (9b) are connected through a third communication pipe (9c) on the outside of the ion exchange device (1) (not illustrated in FIG. 2; see FIG. 3). A valve (11a) is installed in the communication pipe (9c).

Further, a valve (11b) and a valve (11c) as supply/discharge means for supplying/discharging a regenerant solution are installed at an end portion of the first communication pipe (9a) and the second communication pipe (9b).

At the time of raw water treatment, the treatment is performed in a state in which the valve (11a) is open and the valve (11b) and valve (11c) are closed. At the time of resin regeneration, the resin regeneration treatment is performed in a state in which the valve (11a) is closed and the valve (11b) and valve (11c) are open.

Note that, as a variation of the device of the present invention, a member that supports the anion exchange tank (2) or the cation exchange tank (3) may be a member other than the tower body trunk (8a), for example, the anion exchange tank (2) or the cation exchange tank (3) may supported only by the frame material (framework) or may be supported by joining together angle steel, and it suffices that the apparatus overall includes a holding member that can stable hold the anion exchange tank (2) and/or the cation exchange tank (3).

Further, although in the aforementioned form, an ion exchange device is described in which the anion exchange tank (2) is disposed in the upper part and the cation exchange tank (3) is disposed in the lower part, FIG. 3 is a schematic drawing illustrating, as an example of the device of the present invention, the ion exchange device (1) that includes the cation exchange tank (3) which is packed with a cation-exchange resin at an upper part of the device and the cation exchange tank (2) which is packed with an anion-exchange resin at a lower part. Although the arrangement of the ion exchange tanks differs from the device shown in FIG. 2, it can be understood that the pipes and other structure are in accordance with the structure of the device shown in FIG. 2.

Although which tank among the anion exchange tank (2) and the cation exchange tank (3) to dispose at the upper part of the tower will differ according to the water treatment equipment to be used in combination with the present ion exchange device as well as the quality of the water to be treated and the like, from the viewpoint of the water quality of the treated water that is obtained, normally the anion exchange tank (2) is disposed in the upper part and the cation exchange tank (3) is disposed in the lower part.

### <Ion Exchange Flow>

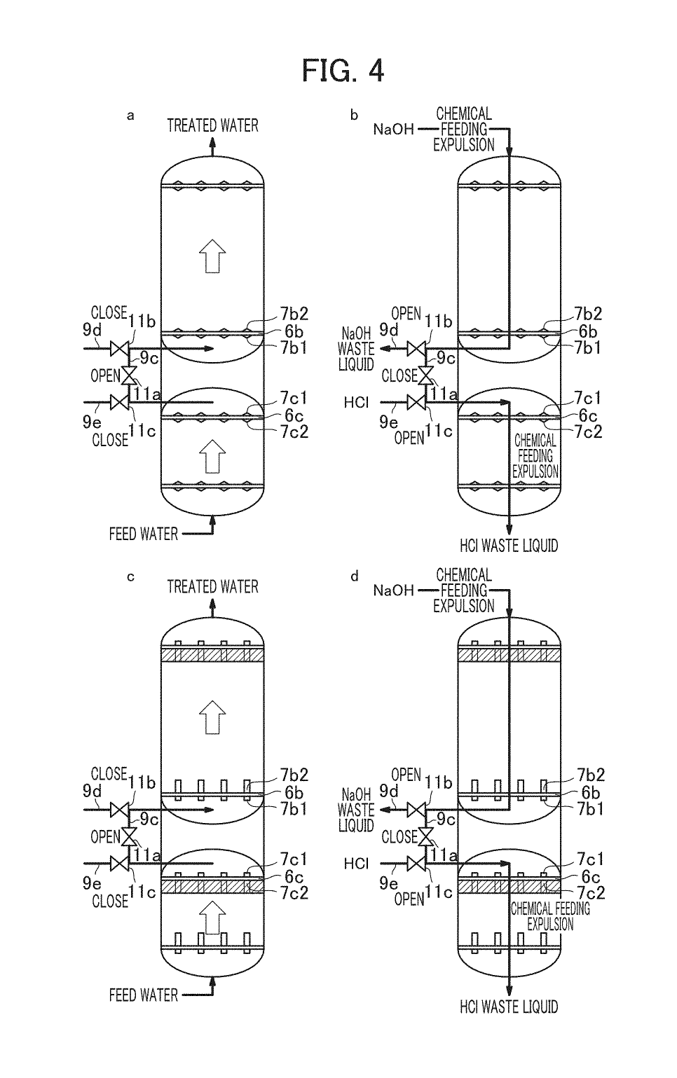

The flow of operations when producing (water sampling) deionized water using the ion exchange device of the present invention is shown in FIG. 4a. In a case where the valve (11b) and the valve (11c) as supply/discharge means for supplying/discharging a regenerant solution are provided at the end portions of the first communication pipe (9a) and the second communication pipe (9b), the valve (11a) is opened and the valve (11b) and the valve (11c) are closed, and raw water (water to be treated) is supplied from the supply/discharge pipe (10b) at the lower portion of the cation exchange tank (3). The raw water flows in sequence through the lower chamber (13d) of the cation exchange tank (3), the water collection/distribution members (7d), the cation-exchange-resin packed chamber (3a), (inert resin (4b) in the case of using cylindrical water collection/distribution members), the water collection/distribution members (7c), the upper chamber (13c), the second communication pipe (9b), the third communication pipe (9c), the first communication pipe (9a), the lower chamber (13b) of the anion exchange tank (2), the water collection/distribution members (7b), the anion-exchange-resin packed chamber (2a), (inert resin (4a) in the case of using cylindrical water collection/distribution members), the water collection/distribution members (7a), the upper chamber (13a) of the anion exchange tank (2), and the supply/discharge pipe (10a) at the upper portion of the anion exchange tank (3), and is taken out as treated water (deionized water).

The flow of operations when regenerating used anion-exchange resin that is packed in the anion-exchange-resin packed chamber (2a) and used cation-exchange resin that is packed in the cation-exchange-resin packed chamber (3a) is illustrated in FIG. 3b. In a case where the valve (11b) and the valve (11c) as supply/discharge means for supplying/discharging a regenerant solution are provided at the end portions of the first communication pipe (9a) and the second communication pipe (9b), the valve (11a) is closed and the valve (11b) and the valve (11c) are opened, and an alkali solution such as NaOH is supplied from the supply/discharge pipe (10a) at the upper portion of the anion exchange tank (3), and an acid solution such as HCl is supplied from a pipe (9e).

The alkali solution flows in sequence from the supply/discharge pipe (10a) through the upper chamber (13a) of the anion exchange tank (2), the water collection/distribution members (7a), (the inert resin (4a) in the case of using cylindrical water collection/distribution members), the anion-exchange-resin packed chamber (2a), the water collection/distribution members (7b), the lower chamber (13b) of the anion exchange tank (2), the first communication pipe (9a) and a pipe 9d, and flows out as regenerant effluent (alkali). By this means, the anion-exchange resin in the anion-exchange-resin packed chamber (2a) is regenerated.

The acid solution flows in sequence from the pipe 9e, via the second communication pipe 9b, through the upper chamber (13c) of the cation exchange tank (3), the water collection/distribution members (7c), (the inert resin (4b) in the case of using cylindrical water collection/distribution members), the cation-exchange-resin packed chamber (3a), the water collection/distribution members (7d), the lower chamber (13d) of the cation exchange tank (3), and the supply/discharge pipe (10b) at the lower portion of the cation exchange tank (3), and flows out as regenerant effluent (acid). By this means, the cation-exchange resin in the cation-exchange-resin packed chamber (3a) is regenerated.

After regeneration is completed, pure water is caused to flow through instead of the HCl solution and NaOH solution shown in FIG. 3b to expel regenerant solution that remains in the respective pipes and resins, and as necessary detergent drainage is discharged while individually cleaning the anion exchange tank (2) and the cation exchange tank (3) with pure water, and thereafter pure water is circulated for a predetermined time period between the anion exchange tank (2) and the cation exchange tank (3), and subsequently the operation returns to the water sampling process. At the time of the regeneration process, movement of the anion-exchange resin and the cation-exchange resin is prevented by the flat plates (6) and the water collection/distribution members (7), and the anion-exchange resin and cation-exchange resin do not mix with each other. Further, the acid solution used for regeneration does not flow into the anion exchange tank (2), and the alkali solution does not flow into the cation exchange tank (3). In addition, because the cation-exchange resin and the anion-exchange resin can be regenerated in parallel at the same time, the regeneration time period can be shortened.

In the ion exchange device of the present invention, the anion exchange tank (2) and the cation exchange tank (3) are provided independently of each other, with the anion exchange tank (2) being disposed in the upper part of the ion exchange device and the cation exchange tank (3) being disposed in the lower part, or with the cation exchange tank (3) being disposed in the upper part and the anion exchange tank (2) being disposed in the lower part. In order to adopt this arrangement, the anion exchange tank (2) and/or the cation exchange tank (3) is supported by the tower body trunk (8a) or a retaining body such as framework. By adopting such a configuration, the installation space is reduced in comparison to a case where the anion exchange tank (2) and the cation exchange tank (3) are each arranged horizontally. Further, the pipes that allow the anion exchange tank (2) and the cation exchange tank (3) to communicate also become shorter than when the tanks (2) and (3) are arranged horizontally. In addition, the height of the tower body can be lowered to a minimum height by suitably modifying the design of the shape or the like of the water collection/distribution members (7) that are used and also adopting suitable modifications with respect to the height of the resin beds of the anion exchange tank (2) and the cation exchange tank (3) by taking into consideration the ion exchange efficiency of the respective resins therein. Furthermore, because the ion exchange tanks are arranged vertically, maintenance of the ion exchange device can also be performed efficiently.

Further, although in the aforementioned form, an ion exchange device is described in which the anion exchange tank (2) is disposed in the upper part and the cation exchange tank (3) is disposed in the lower part, FIG. 3 is a schematic drawing illustrating, as an example of the device of the present invention, the ion exchange device (1) that includes the cation exchange tank (3) which is packed with a cation-exchange resin at an upper part of the device and the cation exchange tank (2) which is packed with an anion-exchange resin at a lower part. Although the arrangement of the ion exchange tanks differs from the device shown in FIG. 2, it can be understood that the pipes and other structure are in accordance with the structure of the device shown in FIG. 2.

### <Water Collection/Distribution Member>

As described above, when members having a conical shape are used as the water collection/distribution members (7), inert resin (4) can be made unnecessary, and it is suitable to make the height of the resin bed in the anion exchange tank (2) around 1.5 to 2.5 times, preferably around two times, the height of the resin bed in the cation exchange tank (3). However, in the present invention, even when using members having a conical shape as the water collection/distribution members (7), use of the ion exchange device of the present invention is not excluded in cases in which inert resin is used, and as described hereunder, an inert resin can be packed as necessary into the ion exchange device of the present invention and used.

In the case of using members having a cylindrical shape as the water collection/distribution members (7), inert resins (4a) and (4b) are packed into the upper portion of the anion-exchange-resin packed chamber (2a) and the cation-exchange-resin packed chamber (3a), respectively, flowage of the cation-exchange resin and the anion-exchange resin is prevented, and liquid is allowed to come in contact evenly with the cation-exchange resin and the anion-exchange resin during water sampling and regeneration, and thus deionized water of high quality is obtained and sufficient regeneration is performed.

In the above-described embodiment the end plate (5b) at the bottom of the anion exchange tank (2) and the end plate (5c) at the top of the cation exchange tank (3) are allowed to communicate through pipes (communication means), and it suffices that the communication means are outside of the respective ion-exchange resin tanks of the ion exchange device. For example, in the case of a tower body that includes the tower body trunk (8), although the communication means may also be outside of the tower body, if space allows it is also favorable to arrange the communication means on the lower side of the ion exchange tanks inside the tower body. Further, although three valves, namely, the valves (11a), (11b) and (11c), are used in this embodiment, a configuration may also be adopted in which switching of flow paths is performed using two three-way valves.

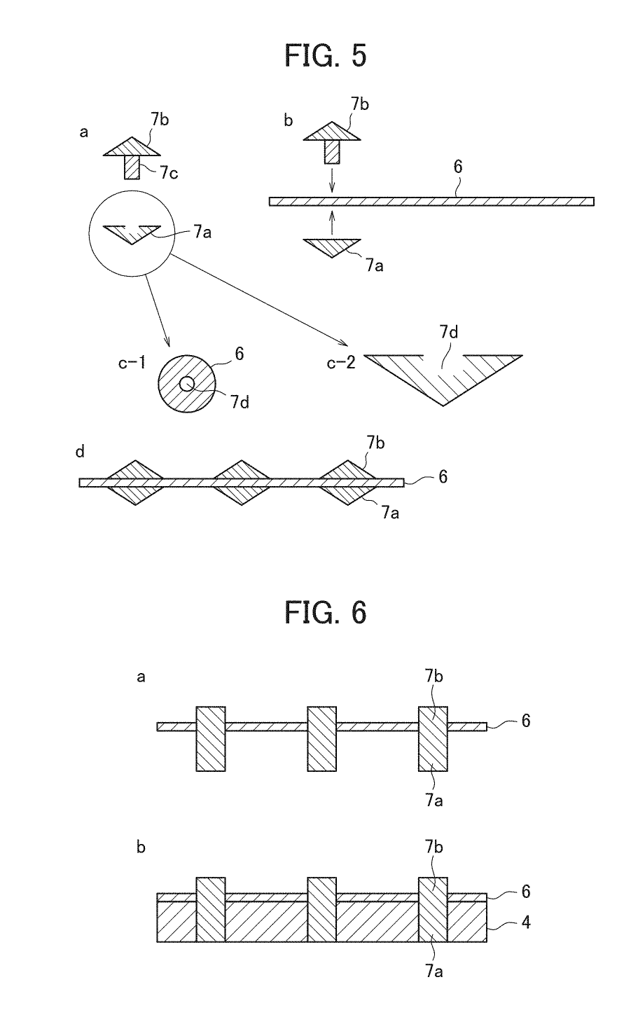

As a specific form in which the water collection/distribution members (7) are installed in a flat plate, a form in which conical water collection/distribution members are installed in a flat plate as illustrated in FIG. 5d (cross-sectional enlarged view) can be mentioned.

The conical water collection/distribution members have a conical water collection/distribution component having a convex portion resembling a male thread as illustrated in FIG. 5a and a concave portion resembling a female thread that can be fitted to the convex portion as illustrated in FIG. 5c, and the convex portion and concave portion can be fixed from both sides of the flat plate as shown in FIG. 5b. With respect to the convex portion that resembles a male thread that is illustrated in FIG. 5a, it is favorable to adopt a configuration in which the inside of the convex portion is hollow and which allows raw water or a regenerant solution such as NaOH or HCl to pass through the hollow portion.

By using conical water collection/distribution members it is considered that (i) treatment with a large flow rate is possible when supplying and discharging raw water and when performing regeneration by means of a regenerant solution, (ii) after performing regeneration by means of a regenerant solution, a regenerant waste solution can be rapidly drained from an ion exchange portion, and (iii) even when using a plurality of water collection/distribution members, variations in the flow velocities of raw water or regenerant solutions among the water collection/distribution members will be small.

As the reason for (i), the location that actually collects and distributes raw water or a regenerant solution is an inclined portion (umbrella-shaped portion) of the conical shape, and because the distance between the top of the conical shape and the flat plate is relatively small, that is, the height of the conical shape is low, the liquid is collected and distributed from the entire inclined portion and not only the top portion. Therefore, the area of a portion involved in collecting and distributing the liquid is comparatively large, and hence a pressure loss caused by feeding of raw water or expulsion of regenerated water is comparatively small. Consequently, even when the flow rate is high during raw water treatment or during regeneration, liquid can pass through smoothly, and this is suitable for bulk treatment and fast regeneration.

As the reason for (ii), because ion-exchange resin will not act appropriately if regenerant waste solution remains after a regeneration treatment, it is necessary to quickly discharge the regenerant waste solution. In the case of water collection/distribution members having a conical shape, because the distance between the top of the conical shape and the flat plate is relatively small, that is, the height of the conical shape is low, the regenerant waste solution is drained from the entire inclined portion and not only the top portion. Further, because the base portion of the cone is connected in a roughly planar manner to the flat plate, the structure is not one which allows regenerant waste solution to build up. Therefore, the regenerant waste solution is quickly discharged and regeneration can be performed in a short time, thus enabling efficient operation of the ion exchange device.

As the reason for (iii), as described in (i) above, because a pressure loss caused by feeding of raw water or expulsion of regenerated water is comparatively small when using water collection/distribution members that have a conical shape, liquid can pass through smoothly and variations in the flow velocities decrease.

The method for fixing the water collection/distribution members to the flat plate is not particularly limited, and the water collection/distribution members may be fixed using an adhesive and not only by means of the male thread and female thread that are described above. In addition, depending on the properties of the material the water collection/distribution members are made of, such as metal, the water collection/distribution members can also be fixed by soldering or welding. FIG. 5d illustrates the state of water collection/distribution members which have been fixed.

Further, cylindrical water collection/distribution members may be installed in the flat plates as illustrated in FIG. 6a (cross-sectional enlarged view). A method for fixing the cylindrical water collection/distribution members to the flat plate is similar to the case of the conical water collection/distribution members described above. In this case, as illustrated in FIG. 6b, a portion at which the cylindrical water collection/distribution members on the side enclosed by upper and lower flat plates protrude may be provided in a state in which the portion is packed with an inert resin (cross-sectional enlarged view).

As described above, with regard to the installation of the water collection/distribution members in the flat plates, the number of water collection/distribution members to be installed and the installation pattern can be appropriately determined by taking into account various factors such as the size and shape of the water collection/distribution members, the ion exchange device, the size of the flat plates, and the amount of raw water treatment that will be required.

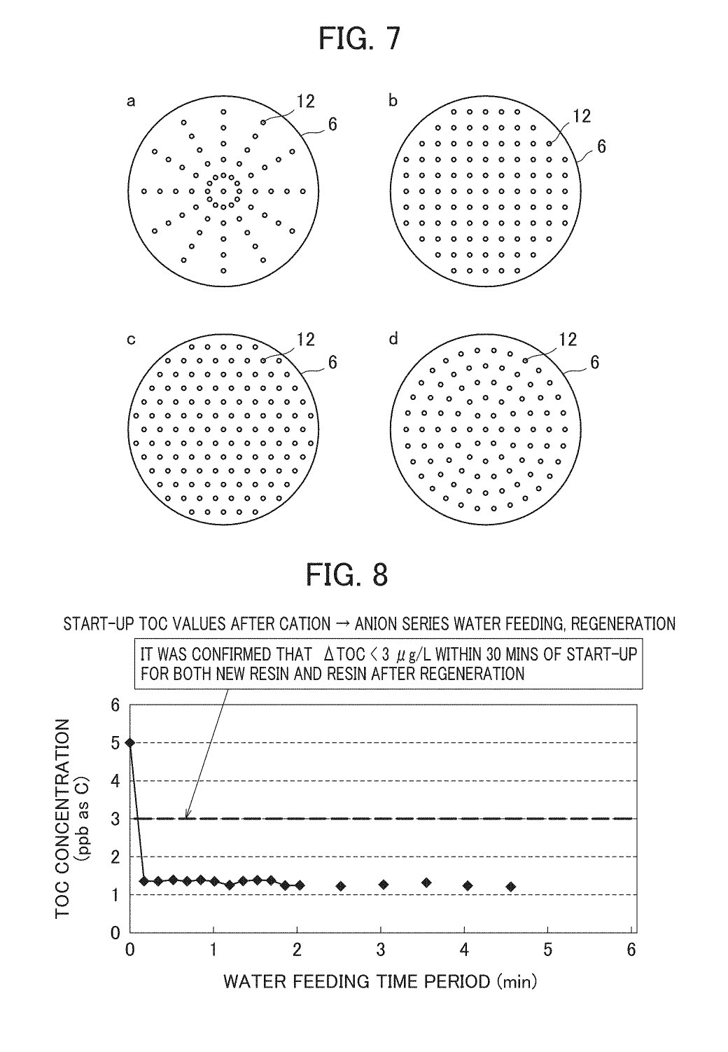

Among these factors, to improve the raw water treatment capacity, in the ion exchange device of the present invention the water collection/distribution members are installed at predetermined intervals in the flat plates. Therefore, with regard to the installation of the water collection/distribution members in the flat plates, as illustrated in FIG. 7a, the water collection/distribution members may be installed at fixed intervals on a plurality of concentric circles that are separated by fixed intervals from the center of the flat plate, or may be installed so as to be at fixed intervals lengthwise and crosswise on the flat plate.

Specifically, various forms can be exemplified such as a form in which the water collection/distribution members are arranged uniformly in the lengthwise and crosswise directions in a manner that includes the center point of the water-impermeable flat plate as illustrated in FIG. 7b, a form in which the water collection/distribution members are arranged uniformly in a diagonal direction that is shifted for each row in a manner that includes the center point of the flat plate as illustrated in FIG. 7c, and a form in which the water collection/distribution members are arranged uniformly on concentric circles that are at fixed intervals from the center point of the flat plate as illustrated in FIG. 7d.

Further, although also depending on the shape of the water collection/distribution members, the water collection/distribution members may be installed so as to project in a conical shape to the ion-exchange resin bed side of the flat plate, and in a case where the water collection/distribution members have a cylindrical shape it is favorable to install the water collection/distribution members so as to project from both the front and rear sides of the flat plate.

In addition, granular inert resin may be packed between the flat plate and the ion-exchange resin bed. In such case, a form which includes beds in which the water collection/distribution members at the upper portion of the anion exchange tank and the water collection/distribution members at the upper portion of the cation exchange tank are respectively embedded in inert resin can be adopted.

In the case of installing water collection/distribution members that have a cylindrical shape, a protruding portion of the water collection/distribution members arises between the flat plate and the ion-exchange resin bed. In such case, if an anion-exchange resin or cation-exchange resin is packed so as to embed the protruding portion of the respective water collection/distribution members therein, there is a risk that raw water will enter into the water collection/distribution members from the vicinity of an inlet of the respective water collection/distribution members (for example, the vicinity of the lower end of the upper water collection/distribution members in each of the anion exchange tank and the cation exchange tank shown in FIG. 4b) during raw water treatment, and the anion-exchange resin or cation-exchange resin located at a position that is above the lower end of the water collection/distribution members will not be able to participate in ion exchange and will thus be wasted.

That is, in a case where water collection/distribution members having a cylindrical shape are used, as illustrated in FIG. 6a, a protruding portion of the water collection/distribution members arises between the flat plate and the ion-exchange resin bed. In this case, although the water collection/distribution members have a structure that allows water to pass therethrough from any position and prevents passage of ion-exchange resin, if raw water is fed into the ion exchange device, the flow of the raw water is such that the raw water initially comes in contact with the lower ends of the water collection/distribution members, and hence the raw water concentrates and flows at the lower end portion of the water collection/distribution members. Therefore, by packing inert resin as dummy resin that does not have an ion-exchange effect in place of anion-exchange resin and cation-exchange resin that is above the lower end of the water collection/distribution members as illustrated in FIG. 6b, there is the advantage that the ion-exchange resin, which is expensive, can be effectively used.

Polyethylene-based resin or polypropylene-based resin or the like that has a smaller specific gravity than ion-exchange resin is used as the inert resin. Preferably the grain size of the inert resin is larger than the grain size of the ion-exchange resin.

### <Details of Device Structure>

In the ion exchange device of the present invention, in a case where the cross-section of each of the anion exchange tank (2) and the cation exchange tank (3) is a substantially circular shape, it is favorable to make the diameter thereof in the range of 500 mm to 3000 mm. By adopting a configuration in which the anion exchange tank (2) and the cation exchange tank (3) have this kind of large diameter, the raw water treatment amount is extremely large and the ion exchange device is also suitable for use, for example, in manufacturing of electronic materials such as semiconductor material.

Further, by making the cross-sectional diameters of the anion exchange tank (2) and the cation exchange tank (3) the same length, the tower body trunk (8) of the ion exchange device can be installed that covers the lower portion of the anion exchange tank (2) and the upper portion of the cation exchange tank (3), and thus the ion exchange device (1) can be provided with a robust structure.

In the present invention, it is suitable to set the bed height of the anion-exchange resin bed in the range of 500 mm to 2000 mm, and more preferably in the range of 750 mm to 1500 mm. Further, it is suitable to set the bed height of the cation-exchange resin bed in the range of 400 mm to 800 mm, and more preferably in the range of 500 mm to 750 mm. In addition, it is suitable to make the bed height of the anion-exchange resin bed 1.5 to 2.5 times higher than the bed height of the cation-exchange resin bed, and more preferably to make the height of the anion-exchange resin bed approximately twice as high as the height of the cation-exchange resin bed.

The ion exchange device of the present invention is a device in which the anion exchange tank (2) is installed above the cation exchange tank, and which includes the tower body trunk (8) that covers the lower portion of the anion exchange tank (2) and the upper portion of the cation exchange tank (3). In addition, it is favorable to make the distance between the lower end of the anion exchange tank (2) and the upper end of the cation exchange tank (3) a distance in the range of 500 mm to 1000 mm. By adopting such a structure, maintenance personnel or the like can enter into the device to perform maintenance of the device and the like, and thus proper management of the device becomes more convenient, and in addition the pipes required for introducing raw water or a regenerant solution and for discharging treated water and a regenerant waste solution can be installed in a space between the lower portion of the anion exchange tank (2) and the upper portion of the cation exchange tank (3), and thus the device can be made compact.

Further, to perform maintenance of the ion exchange device (1), in the side wall of the anion exchange tank (2) and the side wall of the cation exchange tank (3), it is preferable to install a window equipped with a transparent material such as a transparent resin or glass to enable observation of the state of resin packing in the device and the operational status from outside the device, and to also install an ion-exchange resin supply port and discharge port for replacing resin that has been packed inside the device. The size, shape and installation positions of the window and supply port and discharge port for ion-exchange resin may be appropriately designed and applied, and it suffices that the transparent material of the window has a strength such that a hindrance does arise during operation and during regeneration and the like. In addition, for maintenance of the ion exchange device (1), it is preferable to install equipment such as a manhole that enables the entry and exit of a person in the side wall of the anion exchange tank (2) and the cation exchange tank (3) and in the tower body trunk (8) between these exchange tanks, and also in end plate portions provided at the top and bottom of the anion exchange tank (2) and the cation exchange tank (3), respectively.

### <Method of Using Ion Exchange Device>

When operating the ion exchange device (1) of the present invention, it is favorable to feed raw water (water to be treated) to the cation exchange tank (3) at a linear velocity (LV) of 55 m/hr or more, and normally at a linear velocity (LV) in the range of 55 to 75 m/hr. Even when raw water is caused to flow at a high flow rate such as this, the raw water can be adequately treated in the ion exchange device of the present invention. Similarly, in the case of introducing a regenerant solution also, the regeneration time period can be shortened by quickening the flow velocity, and the operating efficiency of the raw water treatment can be improved.

For example, it is favorable to adopt the following values as a guide for the amount of liquid to be fed with respect to the diameter of the tower of the ion exchange device.

TABLE 1

| Tower diameter ϕ | Cross-sectional | Water feeding |
|---|---|---|
| (mm) | area (m²) | amount (m³/hr) |
| 700 | 0.38 | 21~29 |
| 850 | 0.57 | 31~43 |
| 1000 | 0.79 | 43~59 |
| 1500 | 1.77 | 97~132 |
| 1750 | 2.40 | 132~180 |
| 2000 | 3.14 | 172~236 |
| 2500 | 4.91 | 269~368 |
| 3000 | 7.07 | 388~530 |

### Examples

The present invention is described specifically hereunder by way of examples, although the present invention is not limited to only the following examples.

In the following examples, the quantities of CaCO₃, silica (SiO₂) and boron (B) were analyzed as follows.

Analyzer: ICP-MS Agilent 7500 manufactured by Agilent Technologies, Inc.
The analysis method was conducted accordance with JIS K-0133. The TOC concentration was measured using a device (model: Sievers 500 RLe) manufactured by General Electric.
Specific resistance values were measured using a device (model: MX-4) manufactured by DKK-TOA Corporation.

### Example 1 Production of Pure Water by Ion Exchange Device of Present Invention

Pure water was produced under the following conditions using the device illustrating in FIG. 2a.

Properties of raw water (water to be treated):

Boron: 80 ng/L

IC: 1 mg/L as CaCO₃

SiO₂: 20 μg/L

Na: 1 mg/L as CaCO₃

Cl: 0.4 mg/L as CaCO₃

Boron BTC: B≤1 ng/L=0.43 mg-B/L-R

### TOC: 10 ppb

### Ion-Exchange Resins:

Cation-exchange resin: Monosphere 650C UPW (H) manufactured by Dow Chemical Company

Anion-exchange resin: Monosphere 550A UPW (OH) manufactured by Dow Chemical Company

Inert resin: IF-62 manufactured by Dow Chemical Company Water feeding conditions:

Cation exchange tank: SV=150/hr

Anion exchange tank: SV=75/hr

Regeneration conditions (regenerant solution concentrations):

NaOH: 4.0 mass %

HCl: 4.0 mass %

### Size of Devices

Diameter of anion exchange tank: 700 mm

Height of anion-exchange resin bed: 1000 mm

Diameter of cation exchange tank: 700 mm

Height of cation-exchange resin bed: 500 mm

After feeding raw water under the aforementioned water feeding conditions to new resin, the used ion-exchange resin was subjected to regeneration for 30 minutes using the aforementioned regenerant solution, and expulsion was performed using ultrapure water for 30 minutes. Thereafter, cleaning was performed for 15 minutes using raw water, which was followed by feeding of raw water, and the TOC concentration was measured for each water feeding time period that began after cleaning ended.

As a result, as illustrated in FIG. 8, in a case where new resin was used, the TOC became less than 3 μg/L within 30 minutes in the ion exchange device of the present invention.

### Example 2 Influence of Strainer Installation

Water collection/distribution members having the conical shape illustrated in FIG. 5 or water collection/distribution members having the cylindrical shape illustrated in FIG. 6 were used in the device illustrated in FIG. 2a, and recycled water was fed under the aforementioned water feeding conditions to the ion-exchange resins under the same conditions as in Example 1 and the specific resistance value of the water being treated was measured. Note that, in the case of using the water collection/distribution members having the cylindrical shape, measurement was performed in both a case in which an inert resin bed was installed as illustrated in FIG. 6b and a case in which an inert resin bed was not installed.

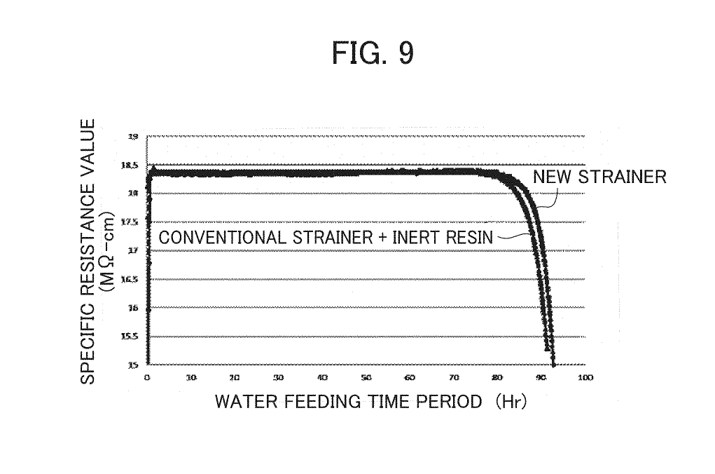

As a result, as illustrated in FIG. 9, it was found that in the case where conical water collection/distribution members were installed, a decrease in the specific resistance value was somewhat slower than in the case where the cylindrical water collection/distribution members (with an inert resin bed) were installed, that is, the ion exchange treatment capacity is large. On the other hand, in the case where cylindrical water collection/distribution members (without an inert resin bed) were installed, the specific resistance value quickly decreased. It is considered that this is because, at the cylindrical water collection/distribution members, resin having an ion exchange capacity could not effectively come in contact with the water to be treated (recycled water), and caused the apparent ion exchange capacity to decrease.

### EXPLANATION OF REFERENCE SIGNS

1 Ion exchange device
2 Anion exchange tank
2a Anion-exchange-resin packed chamber
2b Anion exchange tank cylindrical portion
3 Cation exchange tank
3a Cation-exchange-resin packed chamber
3b Cation exchange tank cylindrical portion
4a, 4b Inert resin
5a, 5b, 5c, 5d End plate
6a, 6b, 6c, 6d Flat plate
7a, 7b, 7c, 7d Water collection/distribution member
8 Ion exchange device tower body trunk
8a Ion exchange device upper-side trunk
8b Ion exchange device lower-side trunk
9a First communication pipe
9b Second communication pipe
9c Third communication pipe
9d, 9e Pipe
10a Anion exchange tank upper portion pipe
10b Cation exchange tank lower portion pipe
11a, 11b, 11c Valve
12 Water collection/distribution member installation hole
13a Anion exchange tank upper chamber
13b Anion exchange tank lower chamber
13c Cation exchange tank upper chamber
13d Cation exchange tank lower chamber

1. An ion exchange device comprising, at an upper part, an anion exchange tank in which an anion-exchange resin is packed, and at a lower part, a cation exchange tank in which a cation-exchange resin is packed, wherein:
the anion exchange tank and the cation exchange tank each independently have an outer shell that is constituted by end plates having an outwardly convex shape that are provided at an upper portion and a lower portion and also by a support body of an ion exchange tank side portion, and comprise an upper chamber, a resin-packed chamber and a lower chamber which are partitioned from each other by two upper and lower flat plates; and
the anion exchange tank and the cation exchange tank are allowed to communicate by communication means provided outside of the anion exchange tank and the cation exchange tank;
the ion exchange device further comprising a supply/discharge pipe for supplying or discharging a liquid to or from the upper portion of the anion exchange tank, and a supply/discharge pipe for supplying or discharging a liquid to or from the lower portion of the cation exchange tank;
the communication means comprising:
a first communication pipe for supplying/discharging a liquid to/from the lower portion of the anion exchange tank,
a second communication pipe for supplying/discharging a liquid to/from the upper portion of the cation exchange tank,
a third communication pipe that allows the first communication pipe and the second communication pipe to communicate,
opening/closing means for opening/closing the third communication pipe, and
supply/discharge means for supplying/discharging a regenerant solution, that is provided in each of the first communication pipe and the second communication pipe;
wherein:
a water collection/distribution member that allows water to pass therethrough and prevents passage of an ion-exchange resin is disposed in the flat plate, and
the supply/discharge pipe at the upper portion of the anion exchange tank, the first communication pipe, the second communication pipe and the supply/discharge pipe at the lower portion of the cation exchange tank communicate with end plates provided at the upper portion and the lower portion of the anion exchange tank and the cation exchange tank, respectively.

2. An ion exchange device comprising, at an upper part, a cation exchange tank in which a cation-exchange resin is packed, and at a lower part, an anion exchange tank in which an anion-exchange resin is packed, wherein:
the cation exchange tank and the anion exchange tank each independently have an outer shell that is constituted by end plates having an outwardly convex shape that are provided at an upper portion and a lower portion and also by a support body of an ion exchange tank side portion, and comprise an upper chamber, a resin-packed chamber and a lower chamber which are partitioned from each other by two upper and lower flat plates; and
the cation exchange tank and the anion exchange tank are allowed to communicate by communication means provided outside of the cation exchange tank and the anion exchange tank;
the ion exchange device further comprising a supply/discharge pipe for supplying or discharging a liquid to or from the upper portion of the cation exchange tank, and a supply/discharge pipe for supplying or discharging a liquid to or from the lower portion of the anion exchange tank;
the communication means comprising:
a first communication pipe for supplying/discharging a liquid to/from the lower portion of the cation exchange tank,
a second communication pipe for supplying/discharging a liquid to/from the upper portion of the anion exchange tank,
a third communication pipe that allows the first communication pipe and the second communication pipe to communicate,
opening/closing means for opening/closing the third communication pipe, and
supply/discharge means for supplying/discharging a regenerant solution, that is provided in each of the first communication pipe and the second communication pipe;
wherein:
a water collection/distribution member that allows water to pass therethrough and prevents passage of an ion-exchange resin is disposed in the flat plate, and
the supply/discharge pipe at the upper portion of the cation exchange tank, the first communication pipe, the second communication pipe and the supply/discharge pipe at the lower portion of the anion exchange tank communicate with end plates provided at the upper portion and the lower portion of the anion exchange tank and the cation exchange tank, respectively.

3. The ion exchange device according to claim 2, wherein the water collection/distribution member is installed at fixed intervals on a plurality of concentric circles that are separated by a fixed interval from a center portion of the flat plate.

4. The ion exchange device according to claim 2, wherein the water collection/distribution member is installed so as to be at fixed intervals lengthwise and crosswise on the flat plate.

5. The ion exchange device according to claim 2, wherein the water collection/distribution member is installed so as to project in an approximately conical shape toward a side of the ion-exchange resin bed of the flat plate.

6. The ion exchange device according to claim 2, wherein the water collection/distribution member has an approximately cylindrical shape and is installed so as to project from both a front side and a rear side of the flat plate.

7. (canceled)

8. (canceled)

9. (canceled)

10. (canceled)

11. (canceled)

12. A method of using an ion exchange device according to claim 2, comprising feeding raw water into a cation exchange tank at a linear velocity (LV) of 50 m/hr or more so as to cause an ion-exchange resin to float and perform treatment of the raw water.

13. The ion exchange device according to claim 1, wherein the water collection/distribution member is installed at fixed intervals on a plurality of concentric circles that are separated by a fixed interval from a center portion of the flat plate.

14. The ion exchange device according to claim 1, wherein the water collection/distribution member is installed so as to be at fixed intervals lengthwise and crosswise on the flat plate.

15. The ion exchange device according to claim 1, wherein the water collection/distribution member is installed so as to project in an approximately conical shape toward a side of the ion-exchange resin bed of the flat plate.

16. The ion exchange device according to claim 1, wherein the water collection/distribution member has an approximately cylindrical shape and is installed so as to project from both a front side and a rear side of the flat plate.

17. The ion exchange device according to claim 15, further comprising beds in which granular inert resin is packed between the flat plates and the ion-exchange resins, and in which the water collection/distribution member of the upper portion of the anion exchange tank and the water collection/distribution member of the upper portion of the cation exchange tank are embedded in the inert resin, respectively.

18. The ion exchange device according to claim 16, further comprising beds in which granular inert resin is packed between the flat plates and the ion-exchange resins, and in which the water collection/distribution member of the upper portion of the anion exchange tank and the water collection/distribution member of the upper portion of the cation exchange tank are embedded in the inert resin, respectively.

19. The ion exchange device according to claim 5, further comprising beds in which granular inert resin is packed between the flat plates and the ion-exchange resins, and in which the water collection/distribution member of the upper portion of the anion exchange tank and the water collection/distribution member of the upper portion of the cation exchange tank are embedded in the inert resin, respectively.

20. The ion exchange device according to claim 6, further comprising beds in which granular inert resin is packed between the flat plates and the ion-exchange resins, and in which the water collection/distribution member of the upper portion of the anion exchange tank and the water collection/distribution member of the upper portion of the cation exchange tank are embedded in the inert resin, respectively.

21. A method of using an ion exchange device according to claim 1, comprising feeding raw water into a cation exchange tank at a linear velocity (LV) of 50 m/hr or more so as to cause an ion-exchange resin to float and perform treatment of the raw water.
